(19) United States
(12) Patent Application Publication
(10) Pub. No.: US 2014/0217115 A1
(43) Pub. Date: Aug. 7, 2014

(54) AUTOMATIC VENDING MACHINE

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: ZHI-YONG GAO, Wuhan (CN); YU-LIN LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/035,975

(22) Filed: Sep. 25, 2013

(30) Foreign Application Priority Data
Feb. 5, 2013 (CN) 2013100446126

(51) Int. Cl. G07F 11/42

(52) U.S. Cl. CPC G07F 11/42
USPC 221/253

(57) ABSTRACT

An automatic vending machine includes a cabinet, a supporting tray secured to the cabinet, a number of transporting devices, and a number of driving devices. Each transporting device comprises a securing member secured to the supporting tray and a transporting belt secured to the securing member. A number of separating panels is located on the transporting belt. An accommodating space is defined between every two adjacent separating panels. Each driving device comprises an engaging post engaged with the transporting belt. The transporting belt is moveable by the engaging post to dispense a product received in the accommodating space.

### BACKGROUND

1. Technical Field

The present disclosure relates to automatic vending machines, and particularly to an automatic vending machine having a buffering device.

2. Description of Related Art

Automatic vending machines allow customers to buy products twenty-four hours a day. When the customer purchases the product from the automatic vending machine, a helical element in a cabinet is rotated to push the product out of the cabinet. However, sometimes the product drops out of the cabinet when the cabinet is shaken, and sometimes the product gets stuck in the helical element. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an automatic vending machine in accordance with an embodiment.

FIG. 2 is an isometric view of a supporting tray, a plurality of transporting devices, and a driving device of the automatic vending machine of FIG. 1.

FIG. 3 is similar to FIG. 2, but viewed from a different aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

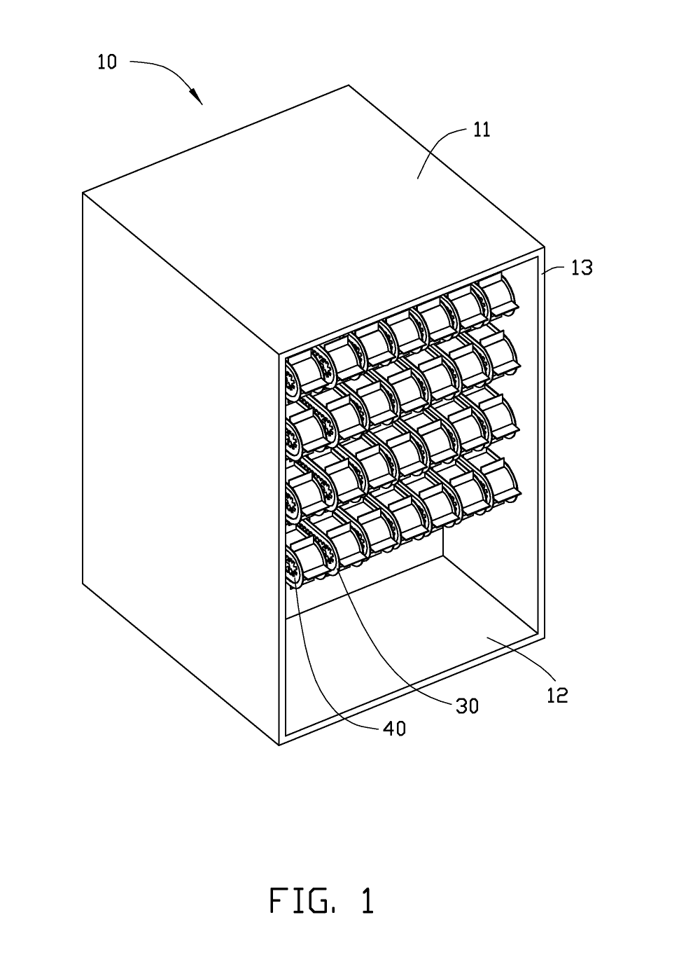

FIGS. 1-3 illustrate an embodiment of an automatic vending machine. The automatic vending machine comprises a cabinet 10, a supporting tray 20 secured to the cabinet 10, a plurality of transporting devices 30 located on the supporting tray 20, and a plurality of driving devices 40 secured to the plurality of transporting devices 30.

The cabinet 10 comprises a top plate 11, a bottom plate 12, and two side plates 13 connected between the bottom plate 12 and the top plate 11. In one embodiment, the top plate 11 is substantially parallel to the bottom plate 12.

The supporting tray 20 comprises a supporting frame 23 and a plurality of connecting poles 25. The supporting frame 23 comprises opposite side panels 231. The connecting poles 25 are located between the opposite side panels 231. Two first securing posts 22 extend from each side panel 231 to secure the supporting tray 20 to the two side plates 13. A second securing post 24 is connected to each connecting pole 25 and each side panel 231, so that the connecting pole 25 is secured to the side panel 231.

Each transporting device 30 comprises a securing member 31 secured to the plurality of connecting poles 25, and a transporting belt 33 secured to the securing member 31. In one embodiment, each connecting pole 25 extends from the securing member 31. The securing member 31 is substantially annular and comprises a receiving space 311. The supporting tray 20 is received in the receiving space 311. The transporting belt 33 comprises a plurality of gear teeth 331. A plurality of separating panels 332 is located on the transporting belt 33. An accommodating space 333 is defined between every two adjacent separating panels 332 for receiving a product.

Each driving device 40 comprises a driving member (not shown) and an engaging post 41 driven by the driving member. In one embodiment, the driving member is a motor and is secured to a first end of the engaging post 41. The engaging post 41 is received in the receiving space 311 and comprises a plurality of engaging teeth 421 meshed with the plurality of gear teeth 331. The plurality of engaging teeth 421 is located on a second end of the engaging post 41. In one embodiment, the diameter of the engaging post 41 is substantially equal to a distance between every two separating panels 332, and a distance between every two adjacent separating panels 332 is substantially equal to each other.

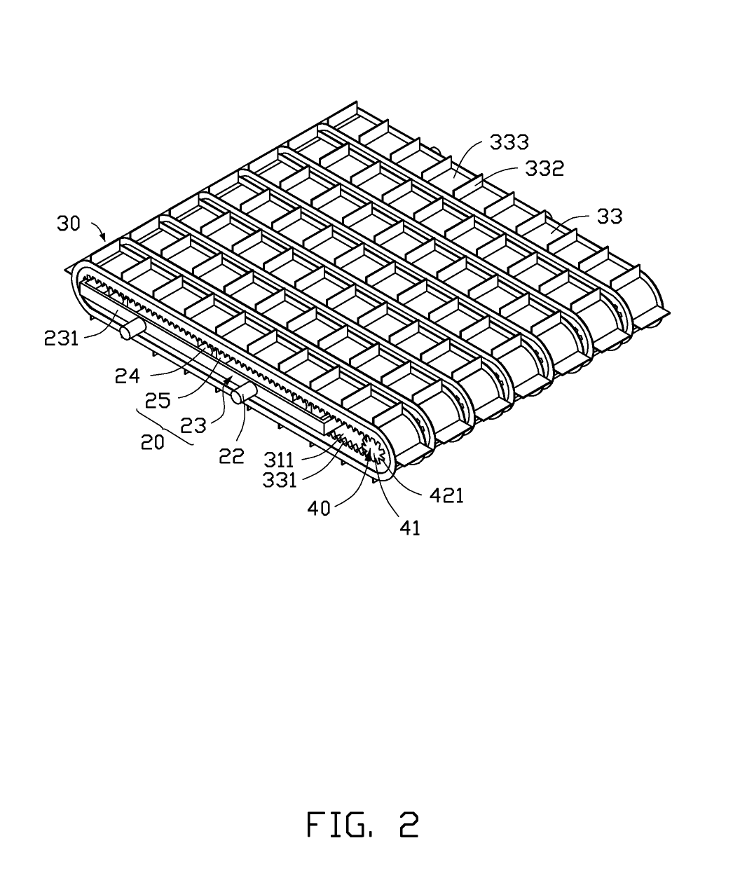

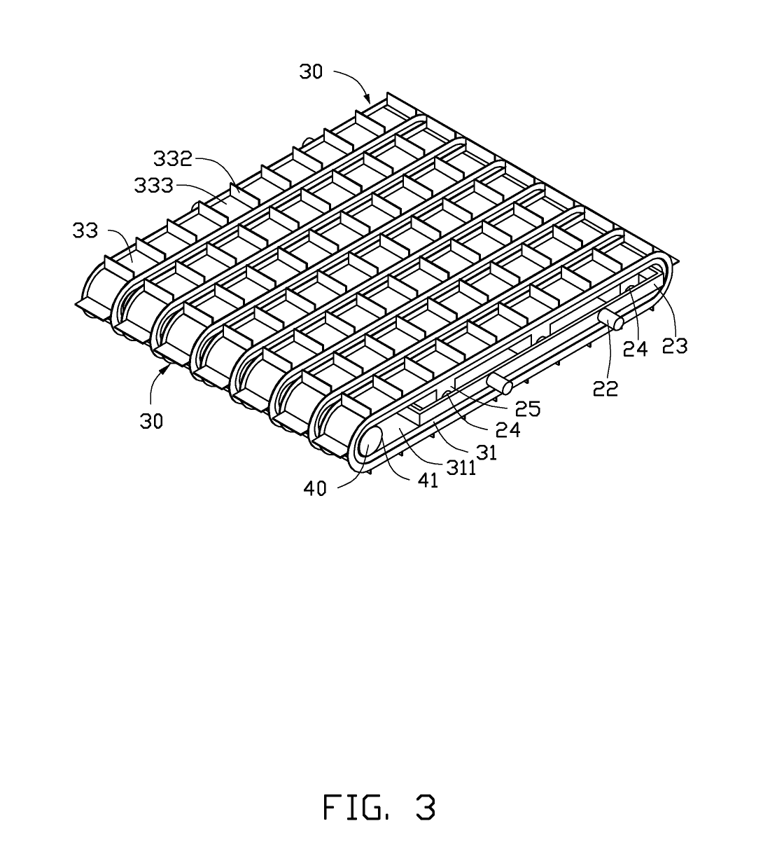

FIGS. 2-3 illustrate that in assembly of the automatic vending machine, the supporting tray 20 is located between the two side plates 13, and the plurality of first securing posts 22 is secured to the two side plates 13. Thus, the supporting tray 20 is secured to the cabinet 10.

In use, the engaging post 41 is rotated one revolution by the driving member, and the transporting belt 33 is moved together with the engaging post 41. Because the diameter of the engaging post 41 is substantially equal to the distance between every two adjacent separating panels 332, and because only one product is received in each accommodating space 333, only one product on the transporting belt 33 is dropped at a time.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An automatic vending machine comprising:
a cabinet;
a supporting tray secured to the cabinet;
a plurality of transporting devices; each transporting device comprises a securing member secured to the supporting tray and a transporting belt secured to the securing member; a plurality of separating panels located on the transporting belt, and an accommodating space defined between every adjacent two separating panels; and
a plurality of driving device; each driving device comprising an engaging post engaged with the transporting belt;
wherein the transporting belt is moveable by the engaging post, to allow product in the accommodating space to be dispense from the accommodating space.

2. The automatic vending machine of claim 1, wherein the transporting belt comprises a plurality of gear teeth, and the engaging post comprises a plurality of engaging teeth meshing with the plurality of gear teeth.

3. The automatic vending machine of claim 1, wherein a diameter of the engaging post is substantially equal to a distance between every adjacent two separating panels.

4. The automatic vending machine of claim 1, wherein the securing member defines a receiving space, the engaging post and the supporting tray are received in the receiving space.

5. The automatic vending machine of claim 1, wherein the supporting tray comprises opposite side panels, and a first securing post extends from the each side panel and is secured to the cabinet.

6. The automatic vending machine of claim 5, wherein the supporting tray further comprises a plurality of connecting poles connected to the opposite side panels, and the plurality of connecting poles is connected to the securing member.

7. The automatic vending machine of claim 6, wherein a second securing post is connected to each side panel and each connecting pole, to connect each connecting pole to each side panel.

8. The automatic vending machine of claim 5, wherein the cabinet comprises a side plate, and the first securing posts is secured to the side plate.

9. An automatic vending machine comprising:
a cabinet;
a supporting tray secured to the cabinet;
a plurality of transporting devices; each transporting device comprises a securing member secured to the supporting tray and a transporting belt secured to the securing member; a plurality of separating panels located on the transporting belt, and an accommodating space defined between every adjacent two separating panels; the transporting belt comprises a plurality of gear teeth; and>
a plurality of driving device; each driving device comprising an engaging post; the engaging post comprises a plurality of engaging teeth; the plurality of engaging teeth mesh with the plurality of gear teeth;
wherein the transporting belt is moveable by the engaging post, to allow product in the accommodating space to be dispense from the accommodating space.

10. The automatic vending machine of claim 9, wherein a diameter of the engaging post is substantially equal to a distance between every adjacent two separating panels.

11. The automatic vending machine of claim 9, wherein the securing member defines a receiving space, the engaging post and the supporting tray are received in the receiving space.

12. The automatic vending machine of claim 9, wherein the supporting tray comprises opposite side panels, and a first securing post extends from the each side panel and is secured to the cabinet.

13. The automatic vending machine of claim 12, wherein the supporting tray further comprises a plurality of connecting poles connected to the opposite side panels, and the plurality of connecting poles is connected to the securing member.

14. The automatic vending machine of claim 13, wherein a second securing post is connected to each side panel and each connecting pole, to connect each connecting pole to each side panel.

15. The automatic vending machine of claim 13, wherein the cabinet comprises a side plate, and the first securing posts is secured to the side plate.
